(19) United States
(12) Patent Application Publication
(10) Pub. No.: US 2024/0056947 A1
(43) Pub. Date: Feb. 15, 2024

(54) METHODS FOR HANDLING NAS MESSAGES FOR UES USING SATELLITE ACCESS FROM A NON-ALLOWED LOCATION

(71) Applicant: Samsung Electronics Co., Ltd., Suwon-si (KR)

(72) Inventors: Mahmoud WATFA, Staines (GB); Chadi KHIRALLAH, Staines (GB); Lalith KUMAR, Bangalore (IN)

(21) Appl. No.: 18/448,011

(22) Filed: Aug. 10, 2023

(30) Foreign Application Priority Data
Aug. 10, 2022 (IN) 202231045704
Jul. 7, 2023 (GB) 2310501.8

(51) Int. Cl. H04W 48/04; H04W 60/00

(52) U.S. Cl. CPC H04W 48/04; H04W 60/00; H04W 84/042

(57) ABSTRACT

The disclosure relates to a 5G or 6G communication system for supporting a higher data transmission rate.

### CROSS-REFERENCE TO RELATED APPLICATIONS

This application is based on and claims priority under 35 U.S.C. § 119 to Indian Patent Application No. 202231045704 filed on Aug. 10, 2022, in the Indian Intellectual Property Office, and United Kingdom Patent Application No. 2310501.8 filed on Jul. 7, 2023, in the UK Intellectual Property Office, the disclosures of which are herein incorporated by reference in their entirety.

### BACKGROUND

### 1. Field

Certain examples of the present disclosure provide various techniques relating to methods for handling non-access stratum (NAS) messages for user equipments (UEs) using satellite access from a non-allowed location, for example within 3^{rd} generation partnership project (3GPP) 5th generation (5G) new radio (NR) and NR-based relay networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service-based architecture or service-based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The purpose of the present disclosure provides an effective methods for handling NAS messages for UEs using satellite access from a non-allowed location. The technical subjects pursued in the disclosure may not be limited to the above-mentioned technical subjects, and other technical subjects which are not mentioned may be clearly understood, through the following descriptions, by those skilled in the art to which the disclosure pertains.

A user equipment, UE, of a communications network using a satellite is provided wherein the UE is accessing the satellite using a public land mobile network, PLMN; the UE receives a down link (DL), non access stratum (NAS), a TRANSPORT message comprising a 5G mobility management (5GMM), cause Information element (IE) indicating that the PLMN is not allowed to operate at the present UE location; and the UE does not send an up link (UL), NAS TRANSPORT message to transport a plurality of data types.

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present disclosure provides an effective and efficient method for handling NAS messages for UEs using satellite access from a non-allowed location.

Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTIONS OF THE DRAWINGS

For a more complete understanding of the present disclosure and its advantages, reference is now made to the following description taken in conjunction with the accompanying drawings, in which like reference numerals represent like parts:

FIG. 1 illustrate a UE according to embodiments of the present disclosure.

### DETAILED DESCRIPTION

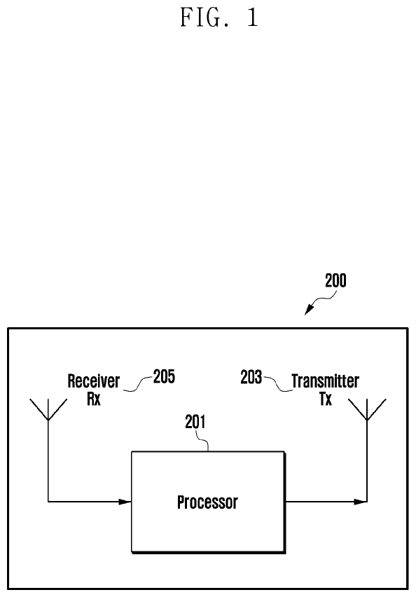

FIG. 1, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The present disclosure is defined in the independent claims. Advantageous features are defined in the dependent claims. Embodiments or examples disclosed in the description and/or figures falling outside the scope of the claims are to be understood as examples useful for understanding the present disclosure.

Other aspects, advantages, and salient features of the present disclosure will become apparent to those skilled in the art from the following detailed description taken in conjunction with the accompanying drawings.

In 3GPP 5G NR, 3GPP 5G Release 16 has been frozen and work on Release 17 is currently underway. An aim of Release 17 is to develop and improve features relating to developing solutions for the use of satellite access for UEs to the evolved packet core (EPC) or the 5G Core (5GC). Satellite access, unlike terrestrial access with NG-RAN coverage (e.g., base stations eNB, gNB, etc.), may span across a country and hence unintentionally provide coverage over a neighboring country. For example, a satellite access may be deployed to provide coverage over a country A but the coverage may “leak” over to country B. A UE which is using the public land mobile network (PLMN) for country A, say PLMN A, may actually cross over to country B and still detect coverage of PLMN A. As such, the UE may physically be in country B and hence is actually roaming but the UE may still be receiving coverage of PLMN A from country A. In this case, when the network detects that the UE location is inaccurate with respect to the PLMN that is supposed to provide services for the UE (i.e., PLMN A is not supposed to serve the UE in country B), then the network may reject a NAS message from the UE, or initiate a NAS procedure to deregister (or detach) the UE from PLMN A. While doing so, the network includes the cause value #78 (“PLMN not allowed to operate at the present UE location”) in the NAS (reject message) that is sent back to the UE.

For 5GC, an access and mobility management function (AMF) may reject a 5G session management (5GSM) message from the UE, or may reject a NAS message (e.g., a mobility management message such as the UL NAS TRANSPORT message) which carries a 5GSM message from a UE, because the UE is not in the correct location. In this case, the AMF sends 5G mobility management (5GMM) cause value #78 to the UE. The 5GMM entity in the UE informs the 5GSM entity in the UE that the 5GSM message was not forwarded because the PLMN is not allowed to operate at the present UE location.

When receiving cause value #78, the UE takes certain actions according to the NAS procedure in question. The detailed UE behaviour is described in 3GPP standard specifications. The following is an example showing how the network behaves when it detects the UE is outside an allowed country and also how the UE behaves when it receives the cause value #78:
“ . . . [SKIP] . . .

If the service request is via a satellite NG-RAN cell, and the network determines that the UE is in a location where the network is not allowed to operate, see 3GPP TS23.502, the network may set the 5GMM cause value in the SERVICE REJECT message to #78 “PLIVIN not allowed to operate at the present UE location.”
. . . [SKIP] . . .
#78 (PLMN not allowed to operate at the present UE location).

This cause value received from a non-satellite NG-RAN cell is considered as an abnormal case and the behaviour of the UE is specified in subclause 5.6.1.7.

The UE may set the 5G Session (5GS) update status to 5U3 ROAMING NOT ALLOWED (and may store it according to subclause 5.1.3.2.2) and may delete 5G-GUTI, last visited registered Tracking Area Identity (TAI), TAI list and identifier ngKSI. Additionally, the UE may reset the registration attempt counter. The UE may store the PLMN identity and, if it is known, the current geographical location in the list of “PLMNs not allowed to operate at the present UE location” and may start a corresponding timer instance (see subclause 4.23.2). The UE may enter state 5GW-DEREGISTERED.PLMN-SEARCH and perform a PLAIN selection according to 3GPPTS23.122.

If the message was received via 3GPP access and the UE is operating in single-registration mode, the UE may handle the Evolved Packet System (EPS) Mobility Management (EMM) parameters EMM state, EPS update status, 4G Globally Unique Temporary Identity (GUTI), last visited registered TAI, TAI list and eKSI as specified in 3GPPTS24.301 for the case when the service request procedure is rejected with the EMM cause with the same value.
. . . [SKIP] . . . ”

Additionally, the UE may initiate the uplink (UL) NAS transport procedure by sending the UL NAS TRANSPORT message in which the UE may include a 5GSM message that is destined towards a session management function (SMF). Also in this case, if the AMF detects that the UE is in a wrong area/location/country, then the AMF may not forward the NAS message to the SMF and rather the AMF may send the down link (DL) NAS TRANSPORT message to the UE and the AMF may include the 5GSM message which was not forwarded to the SMF. The UE NAS 5G Mobility Management (5GMM) layer may forward the 5GSM message to the 5GSM entity i.e., to the 5G NAS session management entity. The following is an excerpt from sections 5.4.5.3.1, 5.4.5.3.2, and 5.4.5.3.3 of 3GPP standard specification that shows the AMF behaviour in this case:
“ . . . [SKIP] . . .

The purpose of the network-initiated NAS transport procedure is to provide a transport of:
. . . [SKIP] . . .
i1) a single UL 5GSM message which was not forwarded because the UE is registered to a PLMN via a satellite NG-RAN cell that is not allowed to operate at the present UE location;
. . . [SKIP] . . .

In case i1) in subclause 5.4.5.3.1, i.e., upon sending a single UL 5GSM message which was not forwarded because the UE is registered to a PLMN via a satellite NG-RAN cell that is not allowed to operate at the present UE location, the AMF may:
a) include the payload data unit (PDU) session ID in the PDU session ID information element (IE);
b) set the payload container type IE to “N1 SM information”;
c) set the payload container IE to the 5GSM message which was not forwarded; and
d) set the 5GMM cause IE to the 5GMM cause #78 “PLMN not allowed to operate at the present UE location.”

. . . [SKIP] . . .

Upon reception of a DL NAS TRANSPORT message, the UE may stop the timer T3346 if running.

Upon reception of a DL NAS TRANSPORT message, if the payload container type IE is set to:
. . . [SKIP] . . .
5a) the 5GMM cause IE is set to the 5GMM cause #78 “PLMN not allowed to operate at the present UE location,” the UE passes to the 5GSM sublayer an indication that the 5GSM message was not forwarded because the UE is registered to a PLMN via a satellite NG-RAN cell that is not allowed to operate at the present UE location along with the 5GSM message from the payload container IE of the DL NAS TRANSPORT message;
. . . [SKIP] . . .
g) Receipt of an indication that the 5GSM message was not forwarded due to the PLMN is not allowed to operate at the present UE location

Upon receiving an indication that the 5GSM message was not forwarded because the UE accessing via a satellite NG-RAN cell is informed that the PLMN is not allowed to operate at the present UE location along with a PDU SESSION RELEASE REQUEST message with the PDU session ID IE set to the same value as the PDU session ID that was sent by the UE, the UE may stop timer T3582, abort the procedure and locally release the PDU session.
. . . [SKIP] . . . ”

The following problems have been identified.

Normally, receiving a service reject message may not lead to the UE entering a deregistered state unless the cause value sent is such that it hints to deletion of a UE context in the network. There are many cases in which the reception of service reject in the UE leads to transitioning into a substate of the REGISTERED state although the UE in such a substate may not be able to receive normal service. However at least remaining in a REGISTERED state means that the context of the UE is maintained in the network and therefore the UE's context can be fetched by another network entity e.g., by another AMF in the same or different PLMN.

The problem with the current behaviour is that the UE enters a substate of the DEREGISTERED state due to being in a wrong area/location/country, however this may actually not lead to context deletion since being in a non-allowed area/location/country may merely mean that normal service cannot be obtained. However, it is possible that the UE returns to the correct area/location/country and hence the are/location/country of the UE may be considered to be allowed after mobility. In this case, being in a DEREGISTERED state means that the UE context cannot be re-used and so the UE must re-register again which in turn implies signalling and delay.

Note that this problem applies to both S1 mode and N1 mode.

Receiving a DL NAS TRANSPORT message with cause value #78 does not prohibit the UE from sending another UL NAS TRANSPORT message with other data types.

As indicated earlier, when the UE receives the DL NAS TRANSPORT message, which contains a 5GSM message, with cause #78, the UE only forwards the 5GSM entity.

The problem is that this AMF behaviour only considers the case of the UL NAS TRANSPORT (which is eventually rejected with cause value #78) which is carrying a 5GSM message. However, the same issue can happen with other types of data that can be sent in an UL NAS TRANSPORT message, such as but not limited to, short message service (SMS) or cellular Internet of Things (CIoT) user data, etc. As such, the AMF behaviour currently is not consistent and as such an AMF would actually process other data types even if the UE is not in the correction area/location/country. For example, there is not AMF behaviour on how to reject an SMS that is sent in the UL NAS TRANSPORT message due to the UE being in a wrong area/location/country or in a non-allowed area/location/country. Therefore, a consistent AMF behaviour is required so that the PLMN's policy with respect to not permitting other services due to the UE being in the wrong area/location/country.

The other related problem is that when the UE receives a DL NAS TRANSPORT message with cause value #78, which is currently only associated with a 5GSM message which is not forwarded by the AMF, the UE behaviour is such that it only stops sending 5GSM messages. However as indicated above, the UE may actually have other data to send in an UL NAS TRANSPORT message such as SMS or CIoT user data, or other data types as defined in 3GPP standard specification. Since the AMF does not handle these data types, then the AMF may actually allow them and this leads to inconsistent behaviour, both at the UE and the network, where it is expected that normal services may not be obtained due to sending of cause value #78 to the UE. It would not be advantageous to only block some messages (e.g., 5GSM message) from the UE but not others, e.g., SMS, especially noting that SMS is actually a low priority service. Therefore a consistent behaviour is required at both the UE and the core network with regards to handling cause value #78 and affording it to all the possible services.

Lack of mobility management entity (MME) handling of NAS messages from a UE in connected mode where the UE is in a non-allowed area/location/country.

The AMF in a 5GS handles the UL NAS TRANSPORT message which contains a 5GSM message as has been described earlier for the case when the UE is deemed to be in an area/location/country that is not allowed or when the UE is in a country where the PLMN is not supposed to operate. However, there is no defined behaviour for the MME in EPS which actually handles both NAS mobility management and session management procedures and messages. For a UE in S1, which may have its NAS messages rejected if sent from idle mode, the MME may not reject the message if sent from connected mode. Hence this creates a problem as the network may not be able to enforce its policies for a UE in connected mode.

When the AMF informs the UE that a 5GSM is not forwarded due to the UE's wrong location, i.e., with cause value #78, the UE can continue to send other types of data although the UE is actually not allowed to use the PLMN from that location. For example, the UE can still send SMS, location services message, etc. This may actually lead to unnecessary signaling and power usage in the UE since the AMF may reject those messages again. If the UE does not stop sending this information, then the UE power may simply be wasted and the signaling may increase in the network.

There is no defined behavior for the AMF when it receives other data types from the UE which is determined to be in an area where the PLMN is not allowed to operate (i.e., the UE is in a location which the satellite may not serve). The other data types for which the AMF behavior is missing include: a short message service (SMS), a long term evolution (LTE) positioning protocol (LPP) message container, a UE policy container, a location services message container, a service object request (SOR) transparent container, a UE parameters update transparent container, or a service-level-anonymous access (AA) container. Note that if the AMF behavior is not defined then different networks may act in a non-standardized manner and the overall behavior becomes unpredictable.

There is no mobility management entity (MME) behavior when it receives any of the following NAS messages from a UE which is in a location where the PLMN is not allowed to operate: UPLINK NAS TRANSPORT message, UPLINK GENERIC NAS TRANSPORT message, PDN CONNECTIVITY REQUEST message, PDN DISCONNECT REQUEST message, BEARER RESOURCE ALLOCATION REQUEST message, BEARER RESOURCE MODIFICATION REQUEST message, ESM DATA TRANSPORT message. Note that if the MME behavior is not defined then different networks may act in a non-standardized manner and the overall behavior becomes unpredictable.

The above information is presented as background information only to assist with an understanding of the present disclosure. No determination has been made, and no assertion is made, as to whether any of the above might be applicable as prior art with respect to the present disclosure.

The following description of examples of the present disclosure, with reference to the accompanying drawings, is provided to assist in a comprehensive understanding of the present disclosure, as defined by the claims. The description includes various specific details to assist in that understanding but these are to be regarded as merely exemplary. Accordingly, those of ordinary skill in the art may recognize that various changes and modifications of the examples described herein can be made.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network. For example, the functionality of an IAB node in the examples below may be applied to any other suitable type of entity performing functions of a network node.

The skilled person will appreciate that the present disclosure is not limited to the specific examples disclosed herein. For example:
The techniques disclosed herein are not limited to 3 GPP 5G;
One or more entities in the examples disclosed herein may be replaced with one or more alternative entities performing equivalent or corresponding functions, processes or operations;
One or more of the messages in the examples disclosed herein may be replaced with one or more alternative messages, signals or other type of information carriers that communicate equivalent or corresponding information;
One or more further elements, entities and/or messages may be added to the examples disclosed herein;
One or more non-essential elements, entities and/or messages may be omitted in certain examples;
The functions, processes or operations of a particular entity in one example may be divided between two or more separate entities in an alternative example;
The functions, processes or operations of two or more separate entities in one example may be performed by a single entity in an alternative example;
Information carried by a particular message in one example may be carried by two or more separate messages in an alternative example;
Information carried by two or more separate messages in one example may be carried by a single message in an alternative example;
The order in which operations are performed may be modified, if possible, in alternative examples; and
The transmission of information between network entities is not limited to the specific form, type and/or order of messages described in relation to the examples disclosed herein.

The disclosure defines a standardized UE and network (AMF & MME) behaviour to solve the problems above.

FIG. 1 illustrates a UE according to embodiments of the present disclosure. The skilled person will appreciate that the network entity illustrated in FIG. 1 may be implemented, for example, as a network element on a dedicated hardware, as a software instance running on a dedicated hardware, or as a virtualised function instantiated on an appropriate platform, e.g., on a cloud infrastructure.

The UE 200 comprises a processor (or controller) 201, a transmitter 203 and a receiver 205. The receiver 205 is configured for receiving one or more messages from one or more other entities of the communications network and the satellite. The transmitter 203 is configured for transmitting one or more messages to one or more other entities of the communications network and the satellite. The processor 201 is configured for performing operations as described below.

The present disclosure proposes solutions to the identified problems. Note that some solutions may apply to both S1 mode (EPS) or N1 mode (5GS). The proposals herein can be applied in any order and in any combination.

Receiving cause value #78 may not lead to entering a DEREGISTERED state.

In the present disclosure, when a UE (in S1 mode or N1 mode) receives a Service Reject message with a 5GMM (or the EMM) cause value #78 (PLMN not allowed to operate at the present UE location), then the UE may remain in the REGISTERED state or enter a substate within the REGISTERED state, and hence the UE may not enter the DEREGISTERED state or any substate within the DEREGISTERED state.

For example, when a UE in S1 mode receives the cause value #78 in the Service Reject message, the UE may enter state EMM-REGISTERED.PLMN-SEARCH. The UE may perform a PLMN search/selection according to 3GPP TS23.122. The UE may enter any other sub state of the REGISTERED state but it may not enter the DEREGISTERED state (or any of its sub states).

For example, when a UE in N1 mode receives the cause value #78 in the Service Reject message, the UE may enter state 5GMM-REGISTERED.PLMN-SEARCH. The UE may perform a PLMN search/selection according to 3GPP TS 23.122. The UE may enter any other sub state of the REGISTERED state but it may not enter the DEREGISTERED state (or any of its sub states).

New behaviours after a UE receiving a DL NAS TRANSPORT message with cause value #78 and new AMF behaviour not to process other data types for UEs in non-allowed area/location/countries.

The following disclosure is made for a UE which receives a DL NAS TRANSPORT message with cause value #78 where optionally the DL NAS TRANSPORT message includes a 5GSM message (optionally which was not forwarded by the AMF). The proposals below may be applied by a UE when the listed conditions occur.

The UE may take the following actions in any combination or order:
The UE may enter any of the following states: 5GMM-REGISTERED.ATTEMPTING-REGISTRATION-UPDATE, 5GMM-REGISTERED.NON-ALLOWED-SERVICE, 5GMM-REGISTERED.LIMITED-SERVICE, 5GMM-REGISTERED.PLMN-SEARCH, or any substate of the 5GMM-DEREGISTERED state, or simply 5GMM-DEREGISTERED state;
The UE may enter any of the states above optionally after entering 5GMM-IDLE mode. The UE may optionally enter 5GMM-IDLE mode e.g., by locally releasing the NAS signalling connection. Alternatively, the UE may start the timer T3540 after receiving the DL NAS TRANSPORT with cause value #78;
The UE may change its 5GS update status to 5U2: NOT UPDATED or to 5U3: ROAMING NOT ALLOWED;
The UE may stop the initiation of the UL NAS TRANSPORT message, optionally regardless of the type of data that is included in the UL NAS TRANSPORT. For example, the UE may not send any of the following data types in the UL NAS TRANSPORT:
a single 5GSM message,
an SMS,
a LPP message (see 3GPPT S37.355),
an SOR transparent container,
a UE policy container,
a UE parameters update transparent container,
a location services message (see 3GPP TS24.080 [13A]),
a CIoT user data container,
a Service-level-AA container,
multiple payloads, and/or
any other data type that may defined in the future such that it is transported in/using the UL NAS TRANSPORT message; and/or
The UE may initiate the registration procedure and send a registration request message, or the UE may initiate the service request procedure and send a service request message. Optionally the UE may initiate the de-registration procedure and send a deregistration request message.

The proposals below are made for the AMF as a new behaviour when it receives an UL NAS TRANSPORT message which contains any of the data types listed above (e.g., SMS, LPP, SOR transparent container, etc.) optionally from a UE for which the AMF determines that the UE is not in an allowed area/location/country or for which the AMF determines that services may not be provided over the area/location/country of the UE in question. The AMF may determine the UE's location using any means and as such the proposals herein would still apply.

The AMF may behave based on any combination of the following proposals and optionally in any order:
The AMF discards the contents of the UL NAS TRANSPORT message optionally whenever the Payload container type IE indicates any of the previously listed data types;
When the payload container type IE (in the UL NAS TRANSPORT message) is set to “LTE LPP message container,” “SMS,” “UE policy container,” “location services message container,” or when the payload container type IE indicates any of the previously listed data types, then the AMF may abort the procedure (e.g., the AMF aborts the NAS transport procedure or discards the UL NAS TRANSPORT message, or its contents, etc.);
The AMF initiates the deregistration procedure and sends the deregistration request message to the UE and includes cause value #78;
The AMF sends a configuration update command message and sets its contents such that the AMF requests the UE to perform a registration procedure using the existing NAS signalling connection (i.e., without the release of the current NAS signalling connection). When the UE sends the registration request message following this, then the AMF may reject the registration request and send the registration reject message and include cause value #78 in the NAS message;
The AMF may not process the contents of the UL NAS TRANSPORT message. Additionally/optionally, the AMF may send a DL NAS TRANSPORT message and include cause value #78. The AMF may include the content(s) of the UL NAS TRANSPORT message which were not processed i.e., these contents may be included in the DL NAS TRANSPORT message in the appropriate IE. The AMF may set the payload container type IE to indicate the content type that the AMF received and did not process;
The AMF may send a DL NAS TRANSPORT message without any content but may send the cause value #78;
The AMF may send a 5GMM STATUS message and include any 5GMM cause value e.g., #78; and
The AMF may also abort or discard any NAS response message that the UE sends to the AMF and optionally when the AMF determines that the UE is in an area/location/country where the network may not be providing services. For example, the AMF may discard a security mode complete message, etc., or any other NAS response message when the condition listed is verified as true.

Whenever the UE receives the DL NAS TRANSPORT message with cause value #78, optionally regardless of the content type or regardless of the value of the payload container type IE, the UE may behave as has been proposed above for the case of receiving a DL NAS TRANSPORT message with a 5GSM message (which was not forwarded) and cause value #78. For example, if the DL NAS TRANSPORT message is received in the UE where the message includes 5GMM cause value #78, then the UE may behave as has been proposed above even if the DL NAS TRANSPORT message does not include a 5GSM message. As such, the UE may not attempt to send any UL NAS TRANSPORT message with a 5GSM message or with any other data type. The UE may also change its state or update type, etc., and may apply any of the proposals that have been described earlier. The AMF may also inform the upper layers, e.g., the SMS entity, the entity responsible for sending location information message, or LPP, etc., that the corresponding data content was not sent successfully and may return to the entity any data content that was received with the cause value #78. As such any entity which receives contents from the 5GMM sublayer along with cause value #78 may consider that any previous data which may have been transmitted was not successfully transmitted. The entity may stop sending any more content until the UE successfully registers with any PLMN, including the same PLMN. Upon successful registration with any PLMN (and optionally upon determining that the UE is in an allowed area/location/country), the 5GMM layer may inform the upper layers that data may now be transmitted.

New MME behaviour to handle NAS messages from UEs in a non-allowed area/location/country.

New MME behaviour is proposed, optionally when the MME determines, via any means, that the UE in question is in an area/location/country for which the network is not allowed to operate or provide services, or for a UE which is in a non-allowed area/location/country such that the use of cause value #78 would be required.

The MME may take any of the actions below, in any order or combination, optionally when it detects that the UE is in a non-allowed area/location/country or if the MME detects that the network may not operate in the current area/location/country of the UE:
For any EPS session management (ESM) message that the MME receives, the MME may send a corresponding NAS ESM reject message and include the cause value #78, where this cause value may be defined as an ESM cause value, or any new cause value may be defined as an ESM cause value, where this value may be used so that it provides the same information as the current EPS mobility management (EMM) cause value #78;
For example, if the UE sends a PDN CONNECTIVITY REQUEST message, then the MME sends a PDN CONNECTIVITY REJECT message with the ESM/EMM cause value #78,
For example, if the UE sends a BEARER RESOURCE ALLOCATION REQUEST message, then the MME sends a BEARER RESOURCE ALLOCATION REJECT message with the ESM/EMM cause value #78,
For example, if the UE sends a BEARER RESOURCE MODIFICATION REQUEST message, then the MME sends a BEARER RESOURCE MODIFICATION REJECT message with the ESM/EMM cause value #78, and
In summary, the MME may reject the ESM NAS message. Alternatively any existing ESM cause value may be used;
The MME may abort the ESM procedure. The MME may optionally discard the ESM message or its contents. Afterwards, the MME may initiate a detach procedure. This proposal also applies to an ESM DATA TRANSPORT message or any other ESM message that the MME may receive, and it applies to any ESM procedure as well, which may include an SMS, or when the UE sends an UL GENERIC NAS TRANSPORT message. In any of these cases, the MME may abort the procedure and/or discard the message and optionally discard the contents of the message;
The MME may send an ESM STATUS message and include any ESM cause value such as ESM/EMM cause value #78 or any existing cause value;
Optionally, after taking any of the actions above, the MME may initiate a detach procedure and include cause #78 in a detach request message;
Note that the proposals above apply to any other NAS message that may be an EMM message as well such as, but not limited to, the AUTHENTICATION RESPONSE message, security mode complete message, or any existing NAS message that the UE may send as a response. In this case, the MME may discard the message or abort the procedure if the MME determines that the UE is in an area/location/country where the network is not supposed to provide service for the area/location/country;
The MME may also send a DL GENERIC NAS TRANSPORT message or a DL NAS TRANSPORT message and include EMM cause value #78 as a response to any NAS message that the UE may have sent, such as an ESM message. This does not prohibit the MME from sending a NAS ESM message in response as well. When the UE receives a DL GENERIC NAS TRANSPORT message or a DL NAS TRANSPORT message with cause value #78, the UE may stop sending any UL GENERIC NAS TRANSPORT message or the UL NAS TRANSPORT message or any ESM message until the UE successfully registers with the network e.g., via a tracking area update procedure or an attach procedure; and
The UE may, e.g., upon receipt of any ESM message with cause #78 or any EMM message that has been proposed above with cause value #78, change its EMM state to any state of the EMM-DEREGISTERED state, or any substate of the EMM-REGISTERED state such as EMM-REGISTERED.LIMITED-SERVICE, EMM-REGISTERED PLMN-SEARCH, REGISTERED. EMM-UPDATE-NEEDED. The UE may also change its EPS update status to EU2: NOT UPDATED or to EU3: ROAMING NOT ALLOWED. Additionally or optionally the UE may perform a tracking area update procedure or an attach procedure. The UE may also apply any of the proposals that were made for the UE in N1 mode as described above, e.g., the UE can autonomously release its NAS signalling connection and enter EMM-IDLE mode, the UE may start T3440, etc.

Note that the proposals herein may apply in any order and in any combination. The actions proposed for a UE in N1 mode may apply for a UE in S1 mode with the corresponding/equivalent message names or NAS states, etc., whenever possible/applicable. Similarly, the actions proposed for a UE in S1 mode may apply for a UE in N1 mode with the corresponding/equivalent message names or NAS states, etc., whenever possible/applicable.

Certain examples of the present disclosure provide a network or wireless communication system comprising a first network entity and a second network entity according to any example, embodiment, aspect and/or claim disclosed herein.

Certain examples of the present disclosure provide a computer program comprising instructions which, when the program is executed by a computer or processor, cause the computer or processor to carry out a method according to any example, embodiment, aspect and/or claim disclosed herein.

Certain examples of the present disclosure provide a computer or processor-readable data carrier having stored thereon a computer program according to the preceding examples.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) comprising one or more such apparatuses/devices/network entities, and/or a method therefor. For example, in the following examples, a network may include one or more IAB nodes.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, claim, example and/or embodiment disclosed herein. Certain embodiments of the present disclosure provide a machine-readable storage storing such a program.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the examples disclosed herein.

Throughout the description and claims, the words “comprise,” “contain,” and “include,” and variations thereof, for example “comprising,” “containing,” and “including,” means “including but not limited to,” and is not intended to (and does not) exclude other features, elements, components, integers, steps, processes, functions, characteristics, and the like.

Throughout the description and claims, the singular form, for example “a,” “an,” and “the,” encompasses the plural unless the context otherwise requires. For example, reference to “an object” includes reference to one or more of such objects.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example or claim disclosed herein unless incompatible therewith.

While the present disclosure has been shown and described with reference to certain examples, it will be understood by those skilled in the art that various changes in form and detail may be made therein without departing from the scope of the present disclosure, as defined by the appended claims.

What is claimed is:

1. A method performed by a user equipment (UE) in a wireless communication system, the method comprising:
receiving, from an access and mobility management function (AMF), a first message comprising information on rejecting a service; and
determining not transmitting, to the AMF, a second message any of a predetermined data type,
wherein the information includes a cause associated with a location of a terminal.

2. The method of claim 1, wherein the first message is included in a non access stratum (NAS) transport message.

3. The method of claim 1, wherein the predetermined data type comprises at least one of:
a single 5^{th} generation session management (5GSM) message;
short message service (SMS);
a long term evolution (LTE) positioning protocol (LPP) message;
a service object request (SOR) transparent container;
a UE policy container;
a UE parameters update transparent container;
a location services message;
a cellular internet of things (CIoT) user data container;
a service-level-anonymous access (AA) container; or
multiple payloads.

4. A method performed by an access and mobility management function (AMF), in a wireless communication system, the method comprising:
receiving, from a user equipment (UE), a first message comprising information associated with a predetermined data type;
identifying, whether the UE has registered to a public land mobile network (PLMN) that is not allowed to operate at a present UE location; and
aborting a procedure associated with the first message.

5. The method of claim 4, wherein the first message is included in a non access stratum (NAS) transport message.

6. The method of claim 4, wherein the predetermined data type comprises at least one of:
short message service (SMS);
a long term evolution (LTE) positioning protocol (LPP) message container;
a UE policy container;
a location services message container;
a service object request (SOR) transparent container;
a UE parameters update transparent container; or
a service-level-anonymous access (AA) container.

7. A method performed by a mobility management entity (MME) in a wireless communication system, the method comprising:
receiving, from a user equipment (UE), a first message;
identifying, whether the UE is in a location where a public land mobile network (PLMN) is not allowed to operate; and
discarding the first message,
wherein the first message comprises at least one of an evolved packet system (EPS) session management (ESM) message or EPS mobility management message (EMM).

8. The method of claim 7, wherein the first message is included in a non access stratum (NAS) transport message.

9. The method of claim 7, wherein the first message comprises at least one of:
a packet data network (PDN) connectivity request message;
a PDN disconnect request message;
a bearer resource allocation request message;
a bearer resource modification request message; or
a ESM data transport message.

10. A user equipment (UE) in a wireless communication system, the UE comprising:
a transceiver; and
at least one processor coupled with the transceiver and configured to:
receive, from an access and mobility management function (AMF), a first message comprising information on rejecting a service, and
determine not transmitting, to the AMF, a second message any of a predetermined data type,
wherein the information includes a cause associated with a location of a terminal.

11. The UE of claim 10, wherein the first message is included in a non access stratum (NAS) transport message.

12. The UE of claim 10, wherein the predetermined data type comprises at least one of:
a single 5^{th} generation session management (5GSM) message;
short message service (SMS);
a long term evolution (LTE) positioning protocol (LPP) message;
a service object request (SOR) transparent container;
a UE policy container;
a UE parameters update transparent container;
a location services message;
a cellular internet of things (CIoT) user data container;
a service-level-anonymous access (AA) container; or
multiple payloads.

13. An access and mobility management function (AMF), in a wireless communication system, the AMF comprising:
a transceiver; and
at least one processor coupled with the transceiver and configured to:
receive, from a user equipment (UE), a first message comprising information associated with a predetermined data type,
identify, whether the UE has registered to a public land mobile network (PLMN) that is not allowed to operate at a present UE location, and
abort a procedure associated with the first message.

14. The AMF of claim 13, wherein the first message is included in a non access stratum (NAS) transport message.

15. The AMF of claim 13, wherein the predetermined data type comprises at least one of:
short message service (SMS);
a long term evolution (LTE) positioning protocol (LPP) message container;
a UE policy container;
a location services message container;
a service object request (SOR) transparent container;
a UE parameters update transparent container; or
a service-level-anonymous access (AA) container.

16. A mobility management entity (MME) in a wireless communication system, the MME comprising:
a transceiver; and
at least one processor coupled with the transceiver and configured to:
receive, from a user equipment (UE), a first message,
identify, whether the UE is in a location where a public land mobile network (PLMN) is not allowed to operate, and
discard the first message,
wherein the first message comprises at least one of an evolved packet system (EPS) session management (ESM) message, or EPS mobility management message (EMM).

17. The MME of claim 16, wherein the first message is included in a non access stratum (NAS) transport message.

18. The MME of claim 16, wherein the first message comprises at least one of:
a packet data network (PDN) connectivity request message;
a PDN disconnect request message;
a bearer resource allocation request message;
a bearer resource modification request message; or
a ESM data transport message.
